(19) United States
(12) Patent Application Publication
(10) Pub. No.: US 2018/0170191 A1
(43) Pub. Date: Jun. 21, 2018

(54) ONBOARD CHARGING DEVICE FOR UNMANNED AERIAL VEHICLE AND VEHICLE INCLUDING THE SAME

(71) Applicant: Beijing Xiaomi Mobile Software Co., Ltd., Beijing (CN)

(72) Inventors: Zheng XING, Beijing (CN); Ningning LI, Beijing (CN); Lei ZHANG, Beijing (CN)

(73) Assignee: Beijing Xiaomi Mobile Software Co., Ltd., Beijing (CN)

(21) Appl. No.: 15/849,111

(22) Filed: Dec. 20, 2017

(30) Foreign Application Priority Data
Dec. 20, 2016 (CN) 201611187863.X

(51) Int. Cl. B60L 11/18; B64F 1/22; B64C 39/02; B64F 1/00

(52) U.S. Cl. CPC B60L 11/1809; B64F 1/005; B64C 39/024; B64F 1/22

(57) ABSTRACT

An onboard charging device and a vehicle including the same are provided for charging an unmanned aerial vehicle. The onboard charging device includes a platform configured to be mounted on top of a vehicle, wherein a charging structure for charging the unmanned aerial vehicle is arranged on the platform. According to the technical solutions of the present disclosure, influence of a factor such as a rugged terrain may be eliminated when the unmanned aerial vehicle lands. Moreover, after landing on the platform, the unmanned aerial vehicle may be directly charged by simple steps through the charging structure on the platform.

### CROSS-REFERENCE TO RELATED APPLICATION

This application is filed based upon and claims priority to Chinese Patent Application of International Application No. CN201611187863.X, filed on Dec. 20, 2016, the entire contents of which are incorporated herein by reference.

### TECHNICAL FIELD

The present disclosure generally relates to the technical field of unmanned aerial vehicles, and more particularly, to an onboard charging device for an unmanned aerial vehicle and a vehicle.

### BACKGROUND

When an unmanned aerial vehicle executes a photographing task in a remote area such as a suburb, the unmanned aerial vehicle is often required to be charged because of its limited flight duration. In a related technology, there is no reliable landing place for an unmanned aerial vehicle, which brings inconvenience to charging.

### SUMMARY

According to a first aspect of the present disclosure, an onboard charging device for an unmanned aerial vehicle is provided, which may include a platform configured to be mounted on top of a vehicle, where a charging structure for charging the unmanned aerial vehicle may be arranged on the platform.

According to a second aspect of the present disclosure, a vehicle is provided, on top of which the onboard charging device for the unmanned aerial vehicle in the abovementioned embodiment is mounted.

The technical solutions provided by the embodiments of the present disclosure may achieve the following beneficial effects: the platform configured for the unmanned aerial vehicle to land is arranged on top of the vehicle, so that influence of a factor such as a rugged terrain may be eliminated when the unmanned aerial vehicle lands. Moreover, after landing on the platform, the unmanned aerial vehicle may be directly charged by simple steps through the charging structure on the platform.

It should be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an onboard charging device for an unmanned aerial vehicle, according to a first exemplary embodiment.

FIG. 2 is an exploded view of an onboard charging device for an unmanned aerial vehicle, according to a first exemplary embodiment.

FIG. 3 is a schematic diagram illustrating a platform of an onboard charging device for an unmanned aerial vehicle in an unfolded state, according to a first exemplary embodiment.

FIG. 4 is a schematic diagram illustrating a platform of an onboard charging device for an unmanned aerial vehicle in a storage state, according to a first exemplary embodiment.

FIG. 5 is a schematic structure diagram of a wireless charging structure, according to a first exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

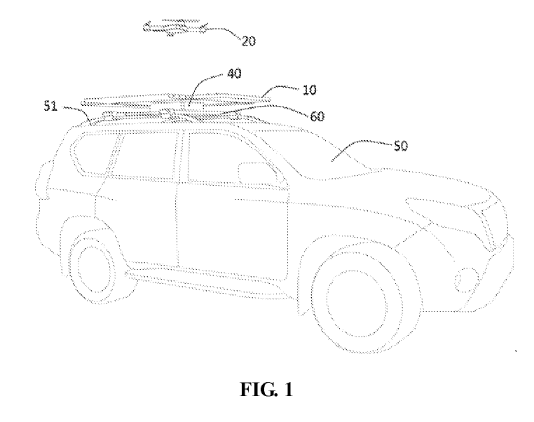

As shown in FIG. 1 to FIG. 4, an exemplary implementation of the present disclosure provides an onboard charging device for an unmanned aerial vehicle (UAV), which includes a platform 10 configured to be mounted on top of a vehicle 50. A charging structure 30 is configured to charge the unmanned aerial vehicle 20, where the charging structure 30 may be arranged on the platform 10. The platform 10 may include a docking station to dock the UAV. The charging structure 30 may include a charger and related supporting circuit.

In addition, as shown in FIG. 1, the present disclosure further provides a vehicle, the onboard charging device for the unmanned aerial vehicle being mounted on top of the vehicle. In such a manner, on one hand, when the unmanned aerial vehicle 20 executes an aerial photographing task in an environment of a rugged terrain of a suburb and the like, the platform 10 in the onboard charging device for the unmanned aerial vehicle provided by the present disclosure may provide a flat landing site for the unmanned aerial vehicle 20, and influence of an external environment is eliminated, so that a blade and the like of the unmanned aerial vehicle 20 may be prevented from being damaged; and on the other hand, the charging structure 30 on the platform 10 may charge the unmanned aerial vehicle 20 to guarantee a flight duration for the unmanned aerial vehicle 20 after the unmanned aerial vehicle 20 lands.

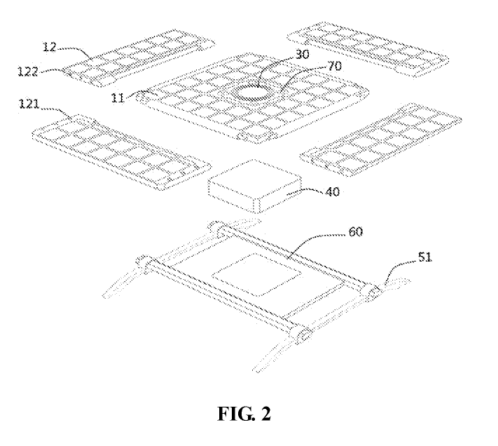

Furthermore, as shown in FIG. 1 and FIG. 2, the charging device may further include a power storage module 40 mounted on the platform 10, and the power storage module 40 is electrically connected with the charging structure 30, so that the power storage module 40 may fit with the charging structure 30 to provide a current output to the unmanned aerial vehicle 20, wherein the power storage module 40 may be, for example, a storage battery.

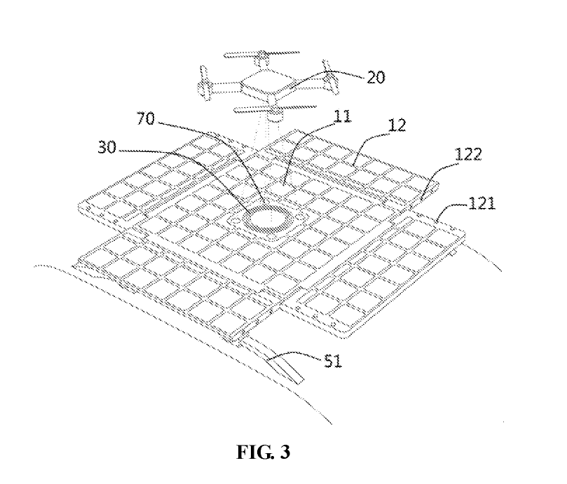

As shown in FIG. 2 and FIG. 3, the charging structure 30 is formed on the platform 10, and an upper surface is flush with the platform 10 to avoid interference and influence on landing of the unmanned aerial vehicle 20. The charging structure 30 may provide a wired output for the unmanned aerial vehicle in a form of plug connection fit and the like with the unmanned aerial vehicle 20, and may also provide a wireless output for the unmanned aerial vehicle in a wireless charging form.

For example, in an implementation of the present disclosure, the charging structure 30 may be a wireless charging structure. When the unmanned aerial vehicle 20 is charged, the wireless charging structure may perform electric signal interaction with the power storage module 40 firstly and then wirelessly output electric power to a battery of the unmanned aerial vehicle 20. The form for wireless charging is well known by those skilled in the art, and will not be elaborated herein. For example, the wireless charging structure may adopt a form such as an electromagnetic sensing form, a magnetic resonance form or a radio wave form. Under such a condition, when the unmanned aerial vehicle 20 is charged, it is only necessary to make the unmanned aerial vehicle 20 land on the platform 10 and position it within an operation range of the wireless charging structure. Such a charging process may complete charging without manual intervention, and is convenient to operate.

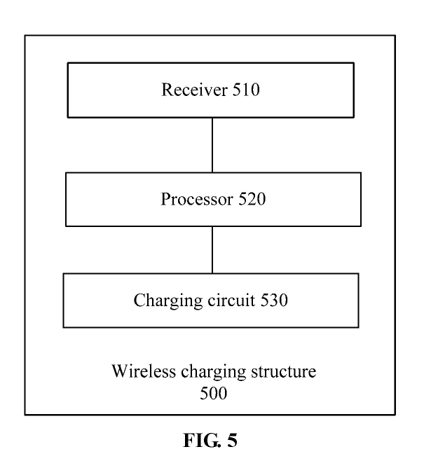

Furthermore, as illustrated in FIG. 5, the wireless charging structure 500 may include: a receiver 510, configured to receive power information of the unmanned aerial vehicle; a processor 520, configured to determine whether the unmanned aerial vehicle has low power or not; and a charging circuit 530, configured to charge the unmanned aerial vehicle when the unmanned aerial vehicle has low power. In such a manner, after the unmanned aerial vehicle 20 lands, the charging device provided by the present disclosure may automatically detect that the unmanned aerial vehicle 20 has insufficient power using the receiver and automatically enter a charging state to recover a flight duration of the unmanned aerial vehicle 20 within a short time; and moreover, after the unmanned aerial vehicle 20 is completely charged, the judgment module determines that the unmanned aerial vehicle 20 has sufficient power, and the charging device may automatically stop the charging process.

In an implementation of the present disclosure, the platform 10 may be a solar panel, and the solar panel is electrically connected with the power storage module 40 to store solar energy in the power storage module 40, thereby timely supplying electric power to the power storage module 40 by virtue of a sufficient solar energy resource. Such a power supply manner is energy-saving and environmentally-friendly.

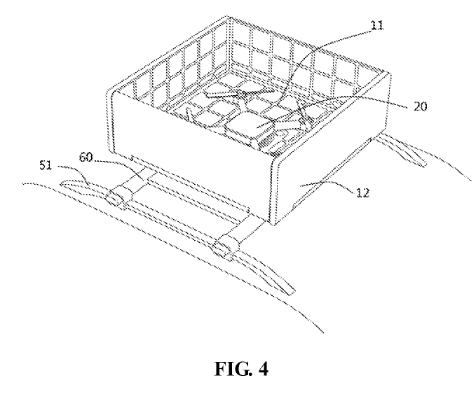

In addition, the platform 10 may include a bottom plate 11 and side plates 12 pivoted to edges of the bottom plate 11. For example, as shown in FIG. 3 and FIG. 4, the bottom plate 11 may be a tetragon, and there are four side plates 12 pivoted to the four edges of the bottom plate 11 respectively. In such a manner, the platform 10 may be endowed with an unfolded state and a storage state. In the unfolded state, the side plates 12 are parallel to the bottom plate 11; and in the storage state, the side plates 12 pivot upwards to form a groove structure capable of accommodating the unmanned aerial vehicle. For example, in an implementation shown in FIG. 4, the four side plates 12 enclose a closed annular structure in the storage state. There are no specific limits made to specific shapes of the bottom plate 11 and the side plates 12.

Alternatively, the bottom plate 11 may also be another polygon, irregular pattern and the like, and the side plates 12 may be other corresponding shapes. In the unfolded state, the platform 10 may provide a relatively large landing space for the unmanned aerial vehicle 20, and moreover, when the bottom plate 11 and the side plates 12 are solar panels respectively, the solar energy may be maximally collected in such a state. In the storage state, the platform 10 accommodates the unmanned aerial vehicle 20 in an enclosing manner, which is convenient and rapid. This may eliminate influence of wind power and the like caused by running of a vehicle on the unmanned aerial vehicle 20 and may also prevent a limited space in the vehicle from being occupied. In addition, since the unmanned aerial vehicle 20 usually lands above the charging structure 30 for charging, in the implementation, the charging structure 30 may be arranged in the center of the bottom plate 11. In such a manner, the unmanned aerial vehicle 20 may be not damaged by overturning of the side plates 12 when landing on the bottom plate 11. The bottom plate 11 may further include locking mechanism to lock the UAV in a fixed position while charging.

The charging device further includes a driving mechanism configured to drive the side plates 12 to pivot relative to the bottom plate 11 to endow the platform with the unfolded state and the storage state. For example, in an implementation, the bottom plate 11 is connected with the side plates 12 through rotating shafts, and the driving mechanism may include a motor capable of driving the rotating shafts and a controller for controlling the motor, a wireless signal receiver being arranged in the controller. An operator may control rotation of the rotating shafts to unfold or overturn upwards the side plates 12 by means of operating the controller through a mobile terminal. The mobile terminal may be, for example, a remote controller or a smart phone. An operating signal is sent to the controller through the remote controller or the smart phone, and after the wireless signal receiver receives the operating signal, the motor may be controlled to be started, thereby implementing movements of the side plates 12.

In order to enable the side plates 12 in the storage state to form the closed annular structure, splicing structures may be arranged between every two adjacent side plates 12. For example, as shown in FIG. 3, an inserted block 121 is arranged on an edge of an upper end face of one side plate 12, and a slot 122 is formed in a side end face of the other adjacent side plate 12. In the storage state, the inserted block 121 may mate with the slot 122, thereby enabling the annular structure formed by the side plates 12 to be stable.

In addition, as shown in FIG. 2 and FIG. 3, positioning sensors 70 configured to guide the unmanned aerial vehicle 20 to land may also be arranged on the platform 10. For example, when the platform 10 is an overturning structure, the positioning sensors 70 are arranged on the bottom plate 11 and are basically positioned in the center of the bottom plate 11 to prevent the unmanned aerial vehicle 20 from being damaged when the side plates 12 are overturned. The positioning sensors 70 may be, for example, fit with a sensor on the unmanned aerial vehicle 20 to enable the unmanned aerial vehicle to accurately land on the platform 10. For example, the positioning sensors 70 may send infrared or photoelectric signals and the like and fit with an optical flow sensor on the unmanned aerial vehicle 20, and the optical flow sensor may recognize positions of the positioning sensors 70, such that the unmanned aerial vehicle 20 may accurately land on the platform 10. Under such a condition, the positioning sensors 70 may be arranged around the charging structure 30, and in such a manner, the unmanned aerial vehicle 20 may land in an area enclosed by the positioning sensors 70, namely positioned above the charging structure 30, so that the unmanned aerial vehicle 20 may be conveniently charged by the charging structure 30.

As mentioned above, the present disclosure further provides a vehicle 50 including a vehicle top. Here, the onboard charging device for the unmanned aerial vehicle may be mounted on the vehicle top. The vehicle 50 may serve as a mobile charging device for the unmanned aerial vehicle 20, and may provide a rising and landing platform for the unmanned aerial vehicle 20.

Furthermore, as shown in FIG. 1 and FIG. 2, the vehicle 50 includes top luggage racks 51, and the platform 10 may be detachably mounted on the top luggage racks 51 through a bracket 60, so that overall stability of the charging device and convenience for operation of a user may be ensured. For example, in an implementation, the bracket 60 may include a pair of beams crossing the two top luggage racks 51 and a base plate positioned between the two beams, and the platform 10 may be mounted on the base plate in form of clamping, threaded connection or the like.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. An onboard charging device for an unmanned aerial vehicle, comprising:
a platform configured to be mounted on top of a vehicle; and
a charging structure disposed on the platform and configured to charge the unmanned aerial vehicle.

2. The onboard charging device for the unmanned aerial vehicle of claim 1, further comprising a power storage module mounted on the platform, wherein the power storage module is electrically connected with the charging structure.

3. The onboard charging device for the unmanned aerial vehicle of claim 1, wherein the charging structure comprises a wireless charging structure.

4. The onboard charging device for the unmanned aerial vehicle of claim 3, wherein the wireless charging structure comprises:
a receiver, configured to receive power information of the unmanned aerial vehicle;
a processor, configured to determine whether the unmanned aerial vehicle has low power or not; and
a charging circuit, configured to charge the unmanned aerial vehicle when the unmanned aerial vehicle has low power.

5. The onboard charging device for the unmanned aerial vehicle of claim 2, wherein the platform comprises a solar panel, and the solar panel is electrically connected with the power storage module.

6. The onboard charging device for the unmanned aerial vehicle of claim 1, wherein the platform comprises a bottom plate and side plates pivoted to edges of the bottom plate, the onboard charging device further comprises a driving mechanism configured to switch the platform from an unfolded state to a storage state by moving at least one of the side plates.

7. The onboard charging device for the unmanned aerial vehicle of claim 1, wherein the platform comprises a bottom plate and side plates pivoted to edges of the bottom plate, the onboard charging device further comprises a driving mechanism configured to drive the side plates to pivot relative to the bottom plate to endow the platform with an unfolded state and a storage state, the side plates are parallel to the bottom plate in the unfolded state, and the side plates pivot upwards to form a groove structure capable of accommodating the unmanned aerial vehicle in the storage state.

8. The onboard charging device for the unmanned aerial vehicle of claim 7, wherein the bottom plate is a tetragon, and the side plates are four side plates pivoted to the four edges of the bottom plate respectively, the four side plates enclosing a closed annular structure in the storage state.

9. The onboard charging device for the unmanned aerial vehicle of claim 7, wherein the driving mechanism comprises a motor and a controller for controlling the motor, and a wireless signal receiver is arranged in the controller.

10. The onboard charging device for the unmanned aerial vehicle of claim 1, wherein positioning sensors are arranged around the charging structure on the platform and configured to guide the unmanned aerial vehicle to land.

11. A vehicle, comprising:
a vehicle top; and
an onboard charging device mounted on the vehicle top and configured to charge an unmanned aerial vehicle (UAV), wherein the onboard charging device comprises: a platform configured to dock the UAV, and a charging structure configured to charge the UAV when the UAV is docked on the platform.

12. The vehicle of claim 11, comprising top luggage racks, wherein the platform is detachably mounted on the top luggage racks through a bracket).

13. The vehicle of claim 12, wherein the charging structure comprises a wireless charging structure.

14. The vehicle of claim 13, wherein the wireless charging structure comprises:
a receiver, configured to receive power information of the unmanned aerial vehicle;
a processor, configured to determine whether the unmanned aerial vehicle has low power or not; and
a charging circuit, configured to charge the unmanned aerial vehicle when the unmanned aerial vehicle has low power.

15. The vehicle of claim 13, wherein the platform comprises a bottom plate and side plates pivoted to edges of the bottom plate, and the platform works in one of an unfolded state and a storage state.

16. The vehicle of claim 15, wherein the platform further comprises a driving mechanism configured to move at least one of the side plates relative to the bottom plate, the driving mechanism cause the side plates to be parallel to the bottom plate in the unfolded state, and the driving mechanism cause the side plates pivot upwards to form a groove structure capable of accommodating the unmanned aerial vehicle in the storage state.

17. The vehicle of claim 16, wherein the bottom plate is a tetragon, and the side plates are four side plates pivoted to the four edges of the bottom plate respectively, the four side plates enclosing a closed annular structure in the storage state.

18. The vehicle of claim 16, wherein the driving mechanism comprises a motor and a controller for controlling the motor.

19. The vehicle of claim 18, further comprising: a wireless signal receiver arranged in the controller.
